(19) United States
(12) Patent Application Publication
(10) Pub. No.: US 2016/0111779 A1
(43) Pub. Date: Apr. 21, 2016

(54) Printed Circuit Board and Wireless Terminal Using Multiple-Input Multiple-Output Antenna Technology

(71) Applicant: ZTE CORPORATION, Guangdong (CN)

(72) Inventors: Jinping MA, Shenzhen (CN); Yang LIU, Shenzhen (CN)

(21) Appl. No.: 14/894,997

(22) PCT Filed: Aug. 23, 2013
(86) PCT No.: PCT/CN2013/082228

§ 371 Date: Dec. 1, 2015

(30) Foreign Application Priority Data
Jun. 3, 2013 (CN) 201310219835.1

(51) Int. Cl. H01Q 1/52; H01Q 1/38; H01Q 21/28

(52) U.S. Cl. CPC H01Q 1/521; H01Q 21/28; H01Q 1/38

(57) ABSTRACT

Disclosed are a printed circuit board and a wireless terminal using the multiple-input multiple-output technology including that printed circuit board, wherein at least two antennas are set on the printed circuit board, among antennas on the printed circuit board, a metal band gap structure is set in a headroom area of at least two adjacent antennas. The printed circuit board and wireless terminal using the multiple-input multiple-output technology including the printed circuit board in the above-mentioned technical scheme effectively improve the isolation between the antennas, solve the interference problem between the multiple antennas, and meet the layout requirements for minimizing multiple antennas of the terminal produces such as cellphones simultaneously.

### TECHNICAL FIELD

The present document relates to the multiple-input multiple-output (MIMO) technical field, in particular, to a printed circuit board and a wireless terminal using the MIMO antenna technology.

### BACKGROUND OF THE RELATED ART

The MIMO or multiple-transmitting multiple-receiving antenna technology is a major breakthrough of the antenna technology in wireless mobile communication field. The technology can multiply the capacity and spectrum utilization of the communication system without increasing the bandwidth, and is the key technology which must be used by the new generation mobile communication system. The MIMO technology allows multiple antennas to transmit and receive multiple spatial streams simultaneously, and can distinguish signals transmitted to or from different spatial orientations. The application of the multiple-antenna system can make the parallel data streams to be transported simultaneously. Meanwhile, multiple antennas are used at a transmitting end or a receiving end, which can significantly overcome the channel fading and reduce the bit error rate.

However, in terminal devices, particularly, handheld terminals are limited by product appearance and size, so achieving multiple antennas in the terminal product has certain difficulty. To solve this technical challenge, the traditional layout is that the locations of the antennas placed are far from each other and the antenna isolation is large enough, this layout can achieve a certain effect. However, at present, the terminal product has the increasingly requirements for appearance, and product miniaturization has become an inevitable trend in the future. This limits that the distance between antennas can not be set ideally, the antenna isolation cannot meet the requirements. Due to the closed physical distance between the antennas, interference between the antennas occurs inevitably. At present, how to overcome the interference between the antennas in the multiple-antenna system at the smaller physical size is a difficult problem urgently to be solved in the industry.

### SUMMARY

The problem to be solved in the embodiment of present document is to provide a printed circuit board and a wireless terminal using the multiple-input multiple-output technology, which effectively improve isolation between antennas, and solve the interference problem between multiple antennas, and meet the layout requirements for minimizing multiple antennas of the terminal products such as cellphones simultaneously.

In order to solve the above-mentioned technical problem, the following technical scheme is adopted:

a printed circuit board, wherein at least two antennas are set on the printed circuit board, moreover, among the antennas on the printed circuit board, a metal band gap structure is set in a headroom area of at least two adjacent antennas.

Alternatively, a structure, a shape and a number of layers of the metal band gap structure are set according to design requirements for isolation between the adjacent antennas.

Alternatively, the metal band gap structure comprises a metal sheet array constituted by a plurality of metal sheets set on the printed circuit board.

Alternatively, the metal sheet array is set on one or more layers in a multi-layer structure of the printed circuit board.

Alternatively, a size of the metal sheet is set according to design requirements for isolation between the adjacent antennas.

A wireless terminal using multiple-Input multiple-output technology comprises any one of the above-mentioned printed circuit boards.

The printed circuit board and wireless terminal using the multiple-input multiple-output technology in the above-mentioned technical scheme effectively improve the isolation between the antennas, solve the interference problem between the multiple antennas, and meet the layout requirements for minimizing multiple antennas of the terminal products such as cellphones simultaneously.

### BRIEF DESCRIPTION OF DRAWINGS

FIG. 1 is a structure diagram of a printed circuit board of a wireless terminal using the multiple-input multiple-output (MIMO) antenna technology in one application example.

### PREFERRED EMBODIMENTS OF THE INVENTION

In order to make the objective, technical scheme and advantage of the present document clear and obvious, the embodiment of the present document is described in detail with reference to the accompanying drawings hereinafter. It should be illustrated that, the embodiments and the features of the embodiments in the present application may be combined with each other arbitrarily without confliction.

### Embodiment The embodiment provides a printed circuit board, at least two antennas are set on the printed circuit board, moreover,

Among antennas on the printed circuit board, a metal band gap structure is set in a headroom area of at least two adjacent antennas.

Wherein, a structure, a shape and a number of layers of the metal band gap structure are set according to debugging requirements for the isolation between the adjacent antennas.

For example, as an optional mode, the metal band gap structure can be a metal sheet array constituted by a plurality of metal sheets set on the printed circuit board, the metal sheet array included in the metal band gap structure can be a square array.

Alternatively, the number of layers of the metal band gap structure can be multiple (i.e. it is a multi-layer structure), which is set according to design requirements for the isolation between the adjacent antennas.

Wherein, the metal sheet array is set on one or more layers in the multi-layer structure of the printed circuit board. The size of the metal band gap structure is set according to debugging requirements for the isolation between the adjacent antennas.

In addition, the present document further provides a wireless terminal using the multiple-input multiple-output technology which comprises the printed circuit board as mentioned above.

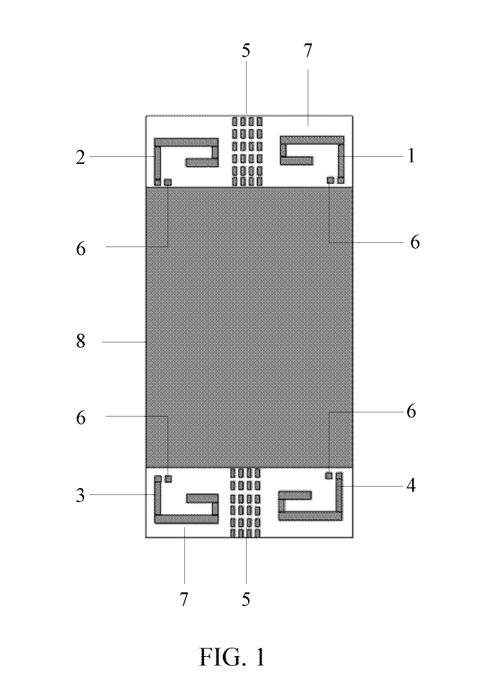

In one application example, a wireless terminal using the multiple-input multiple-output (MIMO) technology is provided, the size of the terminal is 140 mm*60 mm, and it works on the LTE frequency band, due to the limitation on the printed circuit board (PCB) size, the antenna isolation can not be improved by widening the distance between the physical locations on which the antennas are located. As shown in FIG. 1, there are 4 antennas set on a printed circuit board, which are located on four corners of the printed circuit board 8 respectively, for the isolation between antenna 2 and antenna 3, antenna 1 and antenna 3, antenna 2 and antenna 4, since there is an adequate relative physical size, the isolation can directly meet the requirements without taking any measure.

If no other measures are taken, and taking 960 Mhz as example, according to the actual test, the isolation between antenna 1 and antenna 2 is −6.7 dB, the isolation between antenna 2 and antenna 3 is −21 dB, the isolation between antenna 3 and antenna 4 is −7.2 dB, the isolation between antenna 1 and antenna 3, antenna 2 and antenna 4 is around −20 dB. In such antenna layout, the isolation between antennal and antenna 2, antenna 3 and antenna 4 obviously does not meet the requirements. The printed circuit board of present document is used to improve the isolation between antenna 1 and antenna 2, antenna 3 and antenna 4, the application example will be described in details below in combination with FIG. 1.

As shown in FIG. 1, metal sheets 5 which constitute a metal sheet array with 6 rows and 4 columns are covered on the antenna headroom areas between antenna 1 and antenna 2, antenna 3 and antenna 4, this structure is called a metal band gap structure, and this structure can well isolate the antennas from each other, and reduce the mutual interference between two adjacent antennas to the minimum. The metal band gap structure can be located on the surface layer of the printed circuit board and also can be located on the intermediate layer, the number of the layers of the metal band gap structure can be multiple as well, and it is adjusted according to design requirements for the isolation between the adjacent antennas. The size of each metal sheet in the metal band gap can be adjusted according to design requirements for the isolation between the adjacent antennas. The antennas are fed at both sides 6, at this point, although antenna 1 and antenna 2 are still in the common-ground structure, but since the metal band gap structure is adopted between the antennas, the mutual interference between the two antennas has been greatly reduced. The same way is adopted between antenna 3 and antenna 4 to improve the isolation.

At this point, according the actual simulation, after that layout is adopted in the application example, the isolation between antennal and antenna 2 can reach −13.6 dB, which is improved by around 7 dB, if the size of the small metal unit in the metal band gap continues to be optimized, the isolation can be below −15 dB, which basically meets the isolation requirement.

For the antennas working on different ranges of frequency bands, the antenna impedance bandwidth can be adjusted by means of reserving the antenna matching, feed location, the numbers of arrays and layers of the metal band gap, and the size of the small metal unit in the band gap structure.

From the above examples, it can be seen that, compared with the related art, the printed circuit board and wireless terminal using the multiple-input multiple-output terminal provided by the above-mentioned embodiment reduce the mutual interference between ground currents, effectively improve the isolation between the antennas, solve the interference problem between multiple antennas, and meet the layout requirements for minimizing multiple antennas of the terminal products such as cellphones simultaneously by setting between the antennas.

It should be understood by those skilled in the art that the whole or part of the steps in the above method can be completed by a program instructing relevant hardwires, the program may be stored in computer readable storage medium, such as readable memory, magnet disk or optical disk. Alternatively, the whole or part of the steps of the above embodiments can be implemented by one or more integrated circuits. Accordingly, each module/unit in the above embodiments can be implemented by using hardware or software function module. The present document is not limited to any specific form of the combination of the hardware and software.

The above description is only the preferred embodiments of the present document and is not intended to limit the protection scope of the present document. According to the summary of the present document, there can be various other embodiments. Those skilled in the art can make the corresponding modifications and variations according to the present document without departing from the spirit and essence of the present document. All of modifications, equivalents and/or variations made within the spirit and essence of the present document should be embodied in the scope of the appended claims of the present document.

### INDUSTRIAL APPLICABILITY

The printed circuit board and wireless terminal using the multiple-input multiple-output technology in the above-mentioned technical scheme effectively improve the isolation between the antennas, solve the interference problem between the multiple antennas, and meet the layout requirements for minimizing multiple antennas of the terminal products such as cellphones simultaneously. Therefore, the present document has very strong industrial applicability.

What is claimed is:

1. A printed circuit board, wherein at least two antennas are set on the printed circuit board, and wherein,
among the antennas on the printed circuit board, a metal band gap structure is set in a headroom area of at least two adjacent antennas.

2. The printed circuit board of claim 1, wherein,
a structure, a shape and a number of layers of the metal band gap structure are set according to design requirements for isolation between the adjacent antennas.

3. The printed circuit board of claim 1, wherein,
the metal band gap structure comprises a metal sheet array constituted by a plurality of metal sheets set on the printed circuit board.

4. The printed circuit board of claim 3, wherein,
the metal sheet array is set on one or more layers in a multi-layer structure of the printed circuit board.

5. The printed circuit board of claim 3, wherein,
a size of the metal sheet is set according to design requirements for isolation between the adjacent antennas.

6. A wireless terminal using multiple-Input multiple-output technology, comprising the printed circuit board of claim 1.

7. The printed circuit board of claim 2, wherein,
the metal band gap structure comprises a metal sheet array constituted by a plurality of metal sheets set on the printed circuit board.
